(19) United States
(12) Patent Application Publication
(10) Pub. No.: US 2006/0181432 A1
(43) Pub. Date: Aug. 17, 2006

(54) Light emitting reflective hazard alert unit

(76) Inventors: Samuel Silvanus Monteith, Bronx, NY (US); Lydia Fuentebella Knight, Bronx, NY (US)

Correspondence Address: Samuel S. Monteith, 1409 Burke Ave., Bronx, NY, 10469, US

(21) Appl. No.: 11/047,058

(22) Filed: Jan. 31, 2005

(51) Int. Cl. G08G 1/095

(52) U.S. Cl. 340/907

(57) ABSTRACT

An improved light emitting reflective hazard alert unit that is of a triangular configuration when erected, that emits light as a beacon and reflect in light beams aimed in general direction of device. Said invention provides GPS early warning via satellite, and practical for use in any condition. A foldable device conveniently stored in a protective case. Said invention is composed of two upper-blades (70), (70-A) of equal dimension that is hinge-joined to a base-blade (56) nearing both ends of the base-blade (56) using gudgeon (66), (66-A) and pin-rivet (68), (68-A) and overlapping interlocking at unhinge end of upper-blades (70), (70-A) thereby configuring a triangle as in FIG. 1. This invention possess means for illumination affixed to the center section of chassis (92), (92-A), (92-B) and are respectively encased by all concave/convex translucent reflective lenses (80), (80-A), (80-B). The protective-edges (82), (82-A) of the chassis (92), (92-A), (92-B) protect the outer corners of concave/convex translucent reflective lenses (80), (80-A), (80-B from being damaged during handling thereby preventing moisture to enter and causing said invention, the autonomous power supply, on/off switch (28), means for illumination control and GPS are housed in base (30) to become the ballast for said invention. It's the intention of this present invention to promote safety on all roadways during adverse driving conditions, by communicating hazard, and or potential hazards allowing approaching motorist adequate response time.

### BACKGROUND FIELD OF INVENTION

This invention relates to the field of highway safety devices, this is an improved safety triangle, more practical, safe and easy to use hazard alert unit for the every day motorist traveling the highways.

### BACKGROUND DESCRIPTION OF PRIOR ART

Among the types of warning devices regularly in use are standard highway safety triangles with a lower base and upper sections, usually collapsible, triangular shaped devices that are commonly referred to as safety triangle or hazard warning marker. It is a legal requirement that most commercial vehicles carry these devices on board to be used in a potentially hazardous situation in regards to highway safety.

Some methods and designs used to optimize the standard hazard warning triangle is shown in foreign Pat. GB2192017 to Ryland C. Henry (1987), U.S. Pat. No. 5,349,346 to Wu (1994), foreign Pat. GB2312457 to Lin Wei, and Quan Song (1997), U.S. Pat. No. 6,389,720 to Hsieh (2002), U.S. Pat. No. 6,535,117 to Haerer (2003), and U.S. Pat. No. 6,543,165 to Youseph et al (2003), all these devices are unique in its own way however most have shortfalls such as not being able to fold for storage when not in use or non-reflective ability and overtly bulky, while some are a bit complex with delicate external components that may cause the device to be less practical for most applications.

In the foreign Pat.GB2192017 to Ryland C. Henry (1987), the prior art uses bulbs. Bulbs have short lifespan and generate heat when illuminated thus create condensation in cold weather, said prior art has limited mobility a result of using a power cord attached to the vehicle; further more if the battery in the vehicle is dead there would be no electricity to power the device.

With U.S. Pat. No. 5,349,346 to Wu (1994) the prior art has many LED's. LED's can be very bright and when there is too many LED's in a sing the intended image that is being projected becomes distorted; also the lights in this prior art does not blink. Wu's triangle has many external parts to contend with during deployment with limited mobility according to the length of the power cord; also it is non-folding therefore pose a problem in storing it.

In U.S. Pat. No. 6,389,720 to Hsieh (2002), this prior art has flashing light but it does not reflect light. The device is complicated with delicate external parts and is very bulky; this will make storage and usage difficult for the average user.

In U.S. Pat. No. 6,535,117 to Haerer (2003), this prior art is not one complete device it has two separate pieces, the triangle, and an illuminating device that is placed within the center portion of the triangle therefore not projecting an illuminated triangular figure, traditionally the triangle has always been a symbol of caution and this prior art does not project a illuminated triangular figure nor the triangle in the prior art appears as if it would be stable if deployed in windy condition.

In U.S. Pat. No. 6,543,165 to Youseph, et al (2003) this prior art is a light only, non-reflective device similar to that of Hsieh U.S. Pat. No. 6,389,720 they do not reflect light, the light reflecting ability of a safety triangle could act as a back up if the light emitting ability of the device fails said prior art U.S. Pat. No. 6,543,165 does not have a protective edge around it's translucent halves to protect against chips or cracks that might allow moisture to enter causing circuit failure; cracks that could occur while handling, especially with it's overt bulk which could be a problem for the motorists who values storage space.

In U.S. Pat. No. 3,934,541 to May, et al (1976), this prior art has no illumination ability, it was design for use in a time when the average speed limits was 55 mph, on major highways. On today's interstate highways the traffic speed ranges from 65 to 75 mph much faster than the days of the prior art.

### Objects and Advantages

When trucks with a gross weight of 80,000 lbs traveling at 65 to 70 mph, 200 ft. isn't adequate safe stopping distance for such a vehicle on dry road surface, or even traveling 55 mph on an unlit but familiar highway at night shortly after it rained, with headlights from vehicles traveling in opposite direction affecting ones vision, it isn't safe to for any stalled vehicle on the side of such a highway. This invention will provide a multiple alert over a safe distance to allow motorist adequate time to safely respond to any hazard up-ahead.

Therefore accordingly the objects and advantages of this invention is proper to provide an improved light emitting reflective hazard alert unit with GPS that is:

(a) Compactable for storage due to mounting the LEDs on a PC board that is fitted to the chassis wherein achieving a sturdy slender structure, and not a bulky construction.

(b) Fully mobile using own power source and not depending on the vehicle for electricity to operate incases the vehicle have dead battery/batteries.

(c) Not distorted in image projection by oscillating less light emitting diodes (LED).

(d) Easy to assemble and deployed with no detachable external parts to contend with.

(e) Has protection all around the outer edges of the chassis (frame) to protect lenses.

(f) Constructed to reduce and deflect wind pressure, preventing said invention from being blown about, if deployed in high wind; with a cylindrical base, concave/convex lenses to facilitate wind deflection, and wind-slots/apertures to allow the passage of air through the flat sections of structure in accordance with said invention. These improvements enhance stability in high winds.

(g) Capable of reflecting light as a backup if the power source need replacing.

However this invention aim to provide a improved light emitting reflective hazard alert unit in the traditional triangular configuration that is visible over a safe distance allowing motorist adequate time to respond to a potential hazard.

(h) Technically advanced by incorporating GPS transmitter that is activated whenever device is turn on, therefore approaching motor vehicles will be alerted of the stalled vehicle on roadway, or shoulder from a safe distance, upon approach there will be visual conformation of this hazard, (a good device for bad driving conditions).

Said invention is simple to operate, easy to configured, totally moisture resistant with all internal circuitry said invention is totally mobile, with a wide range of visibility due to oscillating light emitting diodes that is visible on both sides of the device.

This present invention is collapsible for compact storage, and lightweight.

The light emitting ability of said invention has the working duration of at least twenty-four consecutive hours under normal circumstances.

Further objects and advantages will become apparent from a study of the following description and accompanying drawings.

### SUMMARY

In accordance with this invention; an improved light emitting reflective hazard alert unit that have the ability to configure a triangular shape when deployed, said invention emits light on interval via means for controlling light, the lights are visible through concave/convex translucent reflective lenses as a beacon across great distance.

This invention transmits a signal using GPS transmitter to forewarn approaching traffic of potential hazard up-ahead before its in visual range; said invention is practical for use in almost any traffic situation where public safety is a concern.

This said invention is a compact collapsible unit for convenient storage; said invention is a composition of two upper-blades of equal dimension that is hinge-joined to both ends of a base-blade, both upper-blades and base-blade is coupled to a base at a central axial point that allow for a ninety degree horizontal rotation of triangular upper portion and base in preparation for deployment.

### DRAWING

Drawing Figures

In these drawings, closely related figures have the same numbers but different alphabetical suffixes.

FIG. 1 is a isometric perspective view of a triangle in its' erected form in accordance with this invention.

FIG. 1-A is a magnified view of a lower corner of said triangle

FIG. 2 is a front view of a triangle in compact collapsed position.

FIG. 3 is a partially exploded perspective view of a cylindrical base.

FIG. 4 is a front view of a cap, (one of two identical caps).

FIG. 5 is a cutaway view of said cap.

FIG. 6 is a exploded inverted view of one of two identical ends of base, cap, and O-ring.

FIG. 7 is a partly cutaway front view of a base-blade fully detached.

FIG. 7-A is a magnified view of a base-blade outer corner.

FIG. 8 is a cutaway end view of a base-blade.

FIG. 9 is a front view of said invention with one upper-blade erected, and other upper-blade partially erected.

FIG. 10 is a fragmentary enlarged front view of both upper-blades in unlocked position.

FIG. 11 is a fragmentary enlarged front view of both upper-blades in locked position.

FIG. 12 is a cutaway front view of a upper-blade.

FIG. 13 is an enlarged fragmentary isometric view of a upper-blade in accordance with this invention showing locking mechanism and a release-boss.

FIG. 14 is a cutaway end view showing alternative configuration of lenses.

FIG. 15 is a fragmentary enlarged cutaway view of center section of a base, and a base-blade.

FIG. 16 is an exploded cutaway end view of a upper-blade showing chassis with convex/concave lenses.

FIG. 17 is a fragmentary vertical front view of a upper-blade without lens, showing chassis with LEDs affixed to PC-board, and PC-board fitted in chassis via PC-retainer-clip.

FIG. 18 is a perspective fragmentary view of an alternative configuration of a base.

FIG. 18-A is a perspective fragmentary view of base in accordance with said invention.

FIG. 19 is a preliminary layout of a integral circuitry in accordance with this invention.

### Improved Light Emitting Reflective Hazard Alert Unit Numerals Reference

20, 20A Caps
22, 22A Stabilizer-recess
24 Flange-mount
26, 26A, 26B Orifice
28 On/Off-switch
30 Base
32, 32A Adhesive-friction-pad
34 Coil-spring
35 Rivet
36 Cap-electrode
37 Rivet-conductor
38 Base-electrode
39 Power-source-retainer
40, 40-A O-A O-ring
42, 42-A O-ring-groove
44 Cap-locking-stud
46 Cap-locking-slot
47 Flange-O-ring
48 Flange-mount-hole
49 Flange-O-ring-groove
50 Flange-shank
52 Flange
54, 54A Stabilizer
56 Base-blade
58 Rotation-stop
60 Flange-mount-rotation-stop
64 Flat-nut
65 Flat-washer
62, 62A Gudgeon
68, 68A Rivet/pin
70, 70A Upper-blade
72, 72A Release-boss
74, 74A, 74B, 74C Retainer-clip
76, 76A Stud
78, 78A Snap-lock
80, 80A, 80B Concave/convex-translucent-reflective-lens
81, 81A, 81B Flat-lens
82 Protective-edge
84 PC-Retainer-clip
86 Rib
88 Light-emitting-diode (LED)
90, 90A Printed-Circuit (PC) board
90, 92A, 92B Chassis
94, 94A wiring-groove
96, 96A, 96B Wind-slot
98 Line for showing how the concave/convex lenses would be fitted to the chassis
100 Rotation line of upper-blades from collapsed to erect position and vice versa

### DETAILED DESCRIPTION

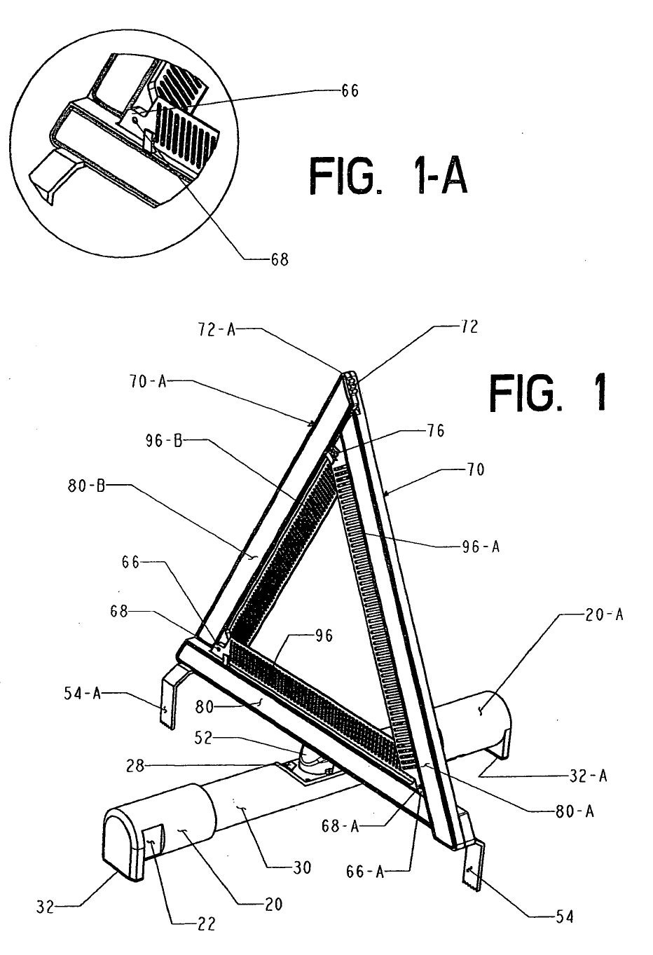

Description—FIGS. 1-13, 15-17, and 18-A-19 are Preferred Embodiment

A preferred embodiment of an improved light emitting reflective hazard alert unit respectively constructed in accordance with the present invention, FIG. 1 is a isometric view of a hazard triangle that is composed of four main parts. a base 30 a base-blade 56 a upper-blade 70, and other upper-blade 70-A. FIG. 1A is a perspective magnified view of one of two hinge-joints of a triangle where the upper-blade 70-A is coupled to the base-blade 56 using a gudgeon 66 and a rivet 68 on one end of upper-blade 70-A, and base-blade 56 forming a hinge joint.

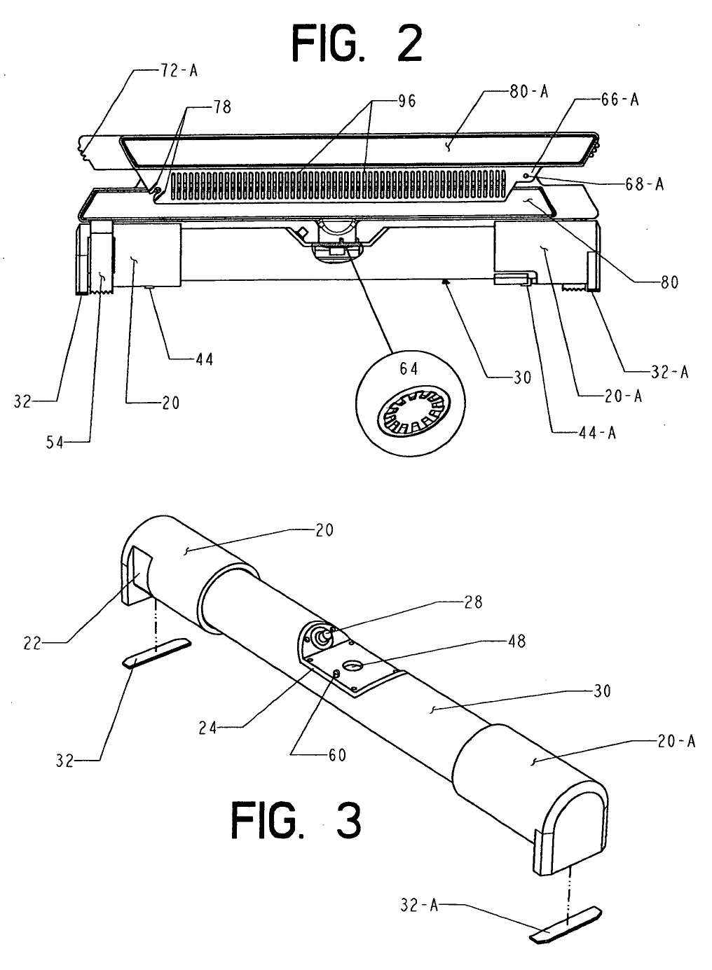

FIG. 2 is a isometric view of said triangle in a completely compact collapsed position also showing is a magnified view of a flat-nut 64 that is used in coupling a base-blade-flange 52 (as in FIG. 8) and base 30 by placing a flange-O-ring 47 in a flange-O-ring-groove 49 then putting a flange-shank 50 through a flange-mount-hole 48 that is located in a flange-mount 24, (as in FIG. 3) then placing a flat-washer 65 (as seen in FIG. 15) onto flange-shank 50 after it passes through the flange-mount 24, at this point the flat-nut 64 is screwed onto the flange-shank 50 thereby coupling base-blade 56 to the flange-mount 24, next step is fitting a PC-board 90-A (LED driver and GPS unit) to underside of the flange-mount 24 using proper fastening means, at this point connect electrical circuitry in said base 30, fit the flange-mount 24 to the base 30 using proper fastening means and sealant, thereby assembling base 30 and base-blade 56, as in FIG. 15.

FIG. 3 is a exploded perspective view of a cylindrical base 30 showing a flange-mount 24 with a on/off-switch 28, and a flange-mount-rotation-stop 60, and two adhesive-friction-pads 32, 32-A also showing is one of two stabilizer-recess 22, (22-A not visible) to accommodate stabilizers 54, 54-A as in FIG. 2, also showing are caps 20,20-A in assembly with the base 30.

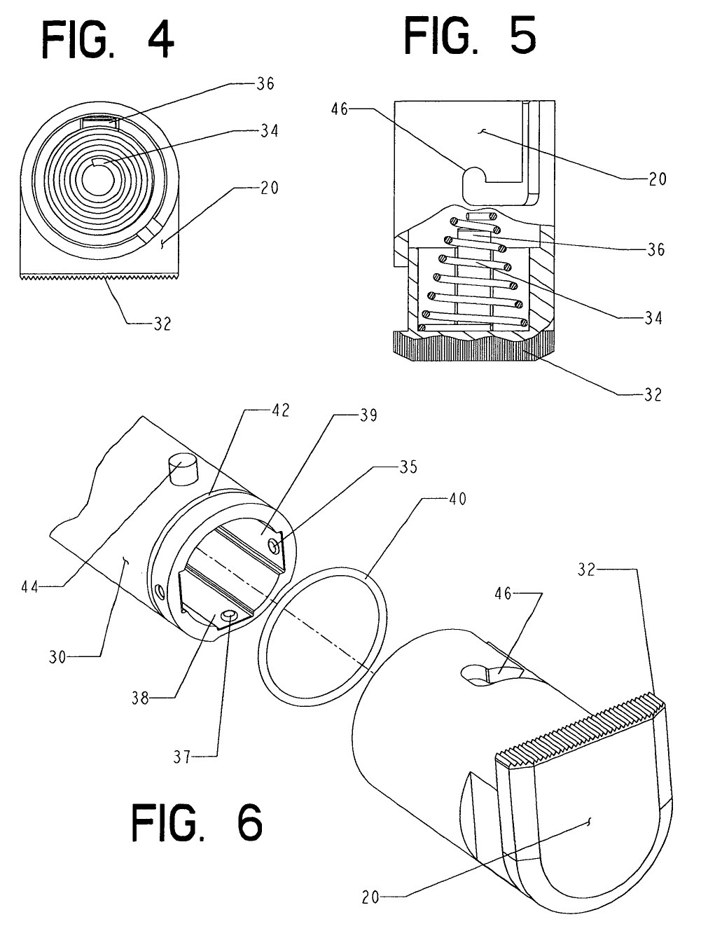

FIG. 4 is a front view of one of two identical caps 20, (20-A not showing) that is used on both ends of the base 30 to secure power source (batteries/power-pack) within the base 30, also showing is a coil-spring 34 that serve as locking aid in conjunction with one of two identical cap-locking-studs 44, (as in FIG. 6) and a cap-locking-slots 46, (as in FIG. 6) as a bayonet style locking mechanism, while coil-spring 34 maintaining firm contact with power source. Connected to the coil-spring 34 is a cap-electrode 36 that makes contact with a rivet-conductor 37 when cap 20, 20-A is fitted to the base 30.

FIG. 5 is a perspective cutaway view of said cap 20 showing a coil-spring 34, a adhesive-friction-pad 32, a cap-electrode 36, and a cap-locking-slot 46.

FIG. 6 is a perspective exploded inverted view of one of two identical ends of a cylindrical base 30 showing a cap-locking-stud 44, and a cap-locking-slot 46 used for coupling cap 20 and base 30. a O-ring-groove 42, (42-A not showing) is for installing O-ring 40, (40-A not showing) that is use to seal both ends of the base 30 to ensuring a watertight integrity within the base where electrical components are installed in accordance with said invention.

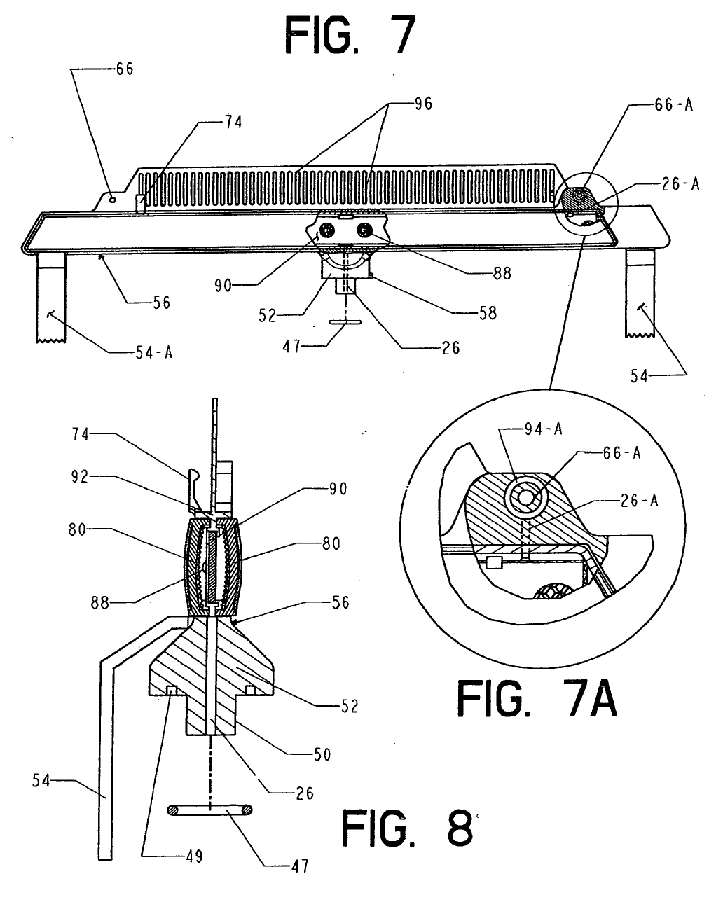

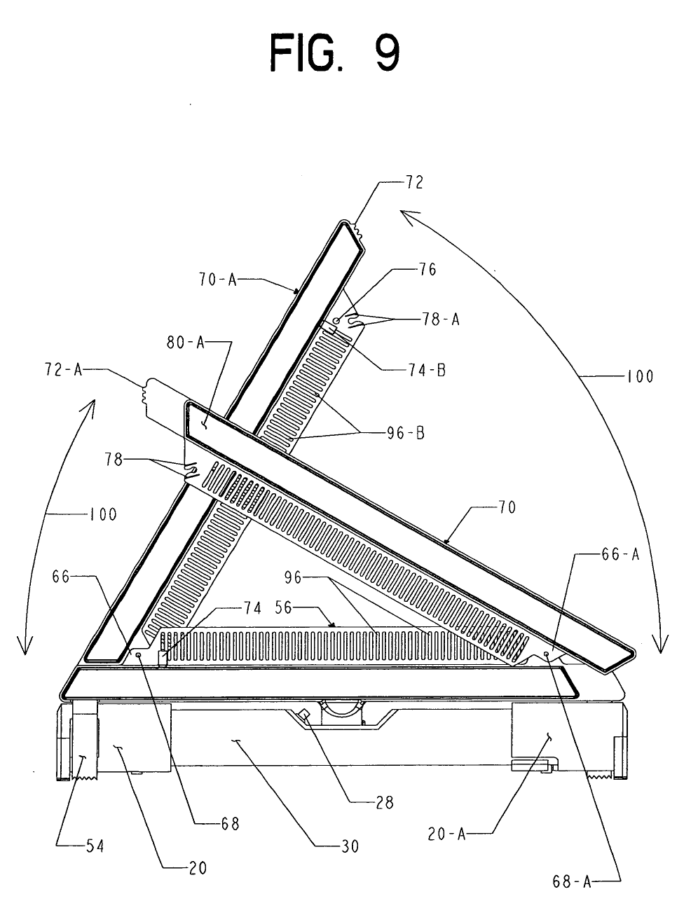

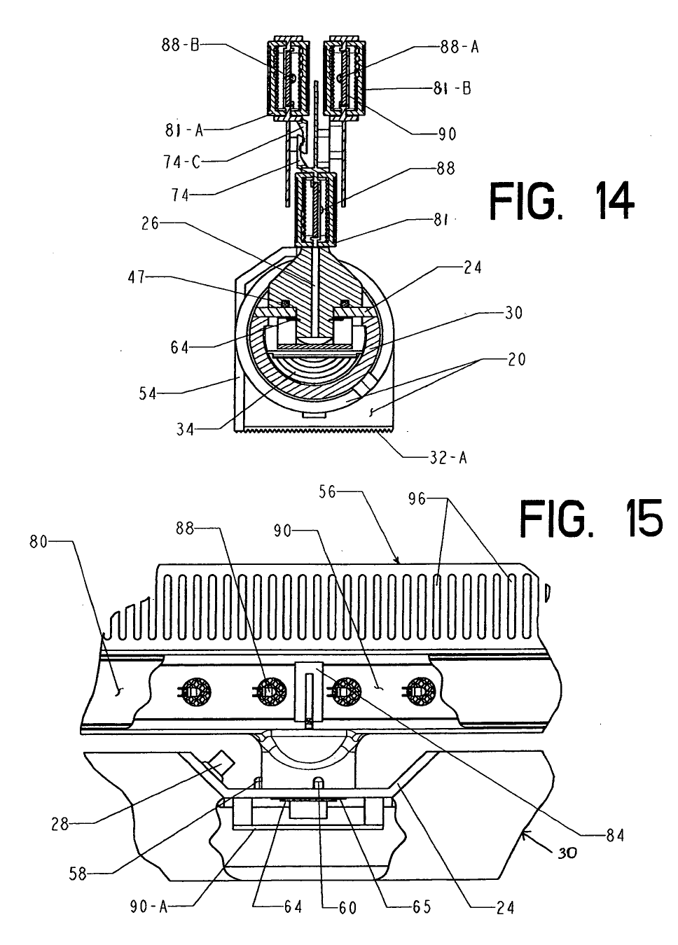

FIG. 7 is a isometric front view of a base-blade 56 detached from said invention showing a plurality of wind-slots 96 that allow wind to pass through inner flat surface of all blades thereby reducing wind pressure against said invention when erected for deployment, also showing gudgeon 66, 66-A at both ends of the base-blade 56, both upper-blades 70, 70-A are coupled on opposite ends of said base-blade 56 by putting rivet 68, 68-A through all gudgeon 66, 66-A to form hinge joints as in FIG. 1A, a retaining-clip 74, (74-A not visible) is used to secure upper-blade 70, 70-A to base-blade 56 when said invention is collapsed and compact for storage as in FIGS. 2 and 14. a orifice 26, 26-A, (26-B not showing) allow wiring to connect all electrical circuit throughout said invention. a wiring-groove 94, and 94-A as in FIG. 7-A, and 17 is part of a passageway that allows wire coming up from base-blade 56 to coil around inside both hinge-joints then connecting PC-board 90 in base-blade 56 to PC-boards 90 in both upper-blades 70, 70-A (wherein wiring is unexposed) as in FIG. 9. a rotation-stop 58 is located at bottom edge of a flange 52, it is used during deployment process to stop the base 30 and the base-blade 56 at end of rotation as in FIG. 1. a stabilizer 54, 54-A. along with base 30 keep said invention in an upright position during deployment as in FIG. 1.

FIG. 8 is a fragmentary end view of a base-blade 56 showing configuration of a stabilizer 54, a lens 80, and a chassis 92, along with a orifice 26 that allow wiring to pass through a flange 52 to upper circuits, a flange-o-ring 47 seats in a flange-o-ring-groove 49 to seal against moisture after flange 52 and flange-mount 24 are coupled as in FIG. 14.

FIG. 9 is a front view of said invention showing a upper-blade 70-A fully erected and other upper-blade 70 partially erected. to the inside flat section of triangle in accordance with said invention are wind-slots 96, 96-B, also showing are retainer-clips 74, 74-B (74-A, and 74-C not visible) as in FIGS. 7 and 13. to the unattached end of both upper-blades 70, 70-A are snap-lock 78, 78-A and stud 76 (76-A not visible) means of interlocking both upper-blades 70, 70-A as illustrated in FIGS. 1 and 11. on the said end of upper-blades 70, 70-A are release-boss 72, 72-A that aid in the unlocking of the upper-blades 70, 70-A as in FIGS. 11 and 13, line 100 shows the path of travel for both upper blades when setting up for deployment.

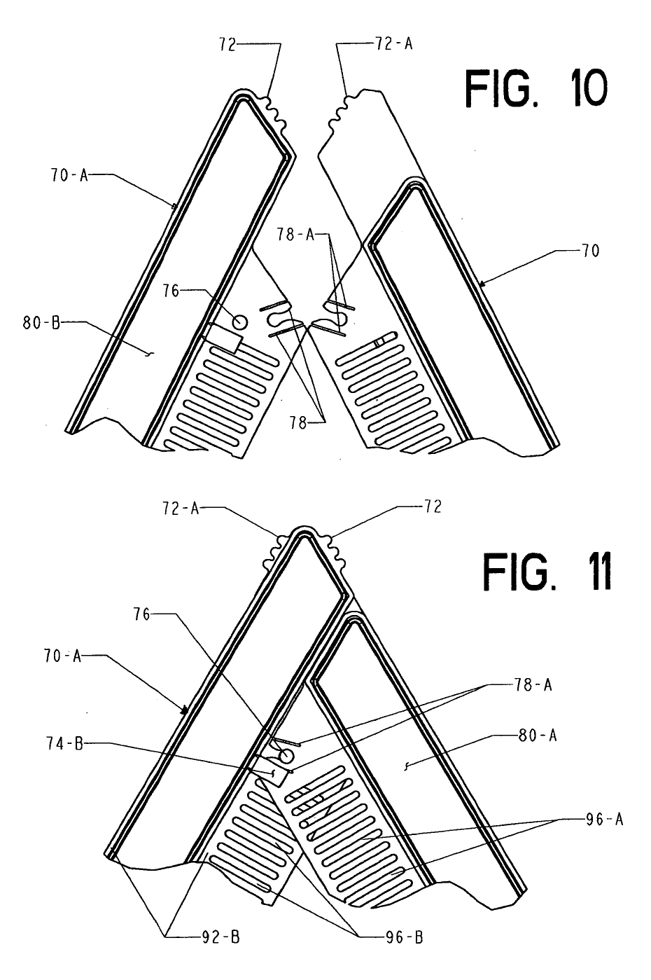

FIG. 10 is a fragmentary view of both upper-blades 70, 70-A showing locking mechanism a snap-lock 78, 78-A on locking end of upper-blade 70, 70-A. as in FIG. 13 is the configuration of a stud 76, (76-A not visible) that works with snap-locks 78, 78-A as a locking mechanism.

FIG. 11 is a fragmentary view of upper-blade 70, 70-A in the locked position.

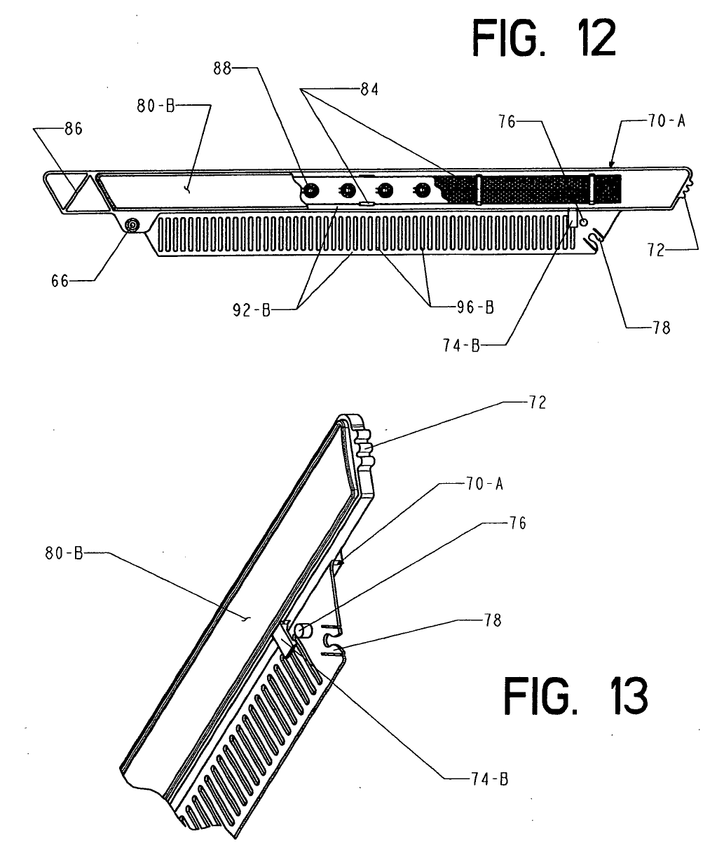

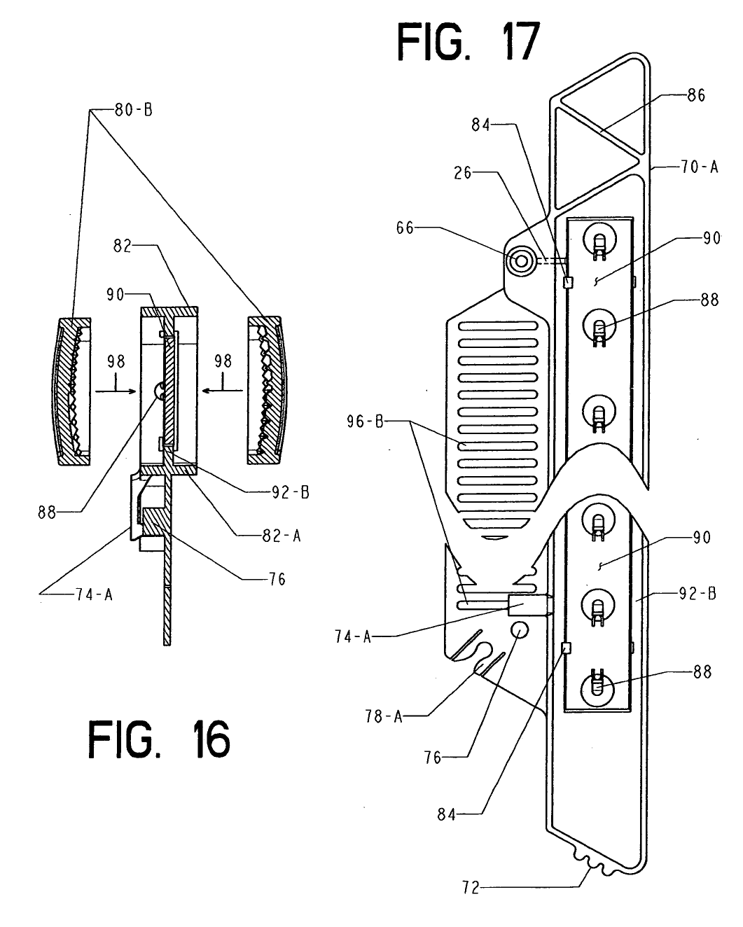

FIG. 12 is a cutaway front view of one of two identical upper-blades 70, 70-A detached, showing a PC-board 90 with LEDs 88 in attachment and multiple PC-board-clip 84, the PC-board with LEDs are encased with concave/convex translucent reflective lenses 80-B of upper-blade 70-A, a protective-edge 82 and 82-A of chassis 92, 92-A, and 92-B protect the outer corners of concave/convex translucent reflective lenses 80, 80-A, and 80-B as in FIG. 16.

FIG. 13 is as illustrated above.

FIG. 14 is a cutaway side view of alternative lens configuration, (except for the lenses, the remainder of FIG. 14 is consistent with present invention)

FIG. 15 is a fragmentary cutaway view of said invention showing a base-blade 56 assembled to a base 30; a flat-washer 65 and a flat-nut 64, showing is a printed circuit board/PC-board 90-A (LED driver and GPS means) and showing is a on/off-switch 28, LEDs 88, PC-board-clip 84, and a flange-mount-rotation-stop 60, and flange-rotation-stop 58. assembling lower portion of said invention by inserting power-source-retainer 39, and fasten it with rivet 35 on inside of base the power-source-retainer 39 is used for hold batteries/power-pack at a position, (keeping batteries from going into center of base where light controlling means are installed) while holding batteries in place, power-source-retainer 39 also act as positive (+) contact for power source therefore has a wire connecting both power-source-retainer 39 to a PC-board in center of base 30, both power-source-retainer 39 being installed in both ends of base 30 not only act as retainer, and positive (+) contact it aids locking method by providing a block (using batteries/power-pack) for coil-spring 34 to push against when both caps 20, and 20-A are fitted to base 30, using power-source-retainer 39 and batteries/power pack as a block for coil-spring 34 therefore creating enough spring pressure for locking mechanism while maintaining firm contact with negative (−) end of batteries/power-pack, as in FIGS. 4 and 5 coil-spring 34 and cap-electrode 36 are connected in cap 20, when caps 20 and 20-A are affixed to base 30 cap-electrode 36 make contact with a rivet-conductor 37 that is used to install a base-electrode 38 in a base 30, both base-electrode 38 have insulated wiring connected to a on/off-switch 28 (switch is watertight) where on/off-switch 28 is connected to a PC-board 90-A which is mounted to underside of a flange-mount 24 as in FIG. 15, with all electrical connections completed within lower portion of said invention and a flange-mount 24 is assembled with a base-blade 56, assemble a flange-mount 24 to a base 30 using proper fastening and sealant means to secure and maintain watertight integrity in accordance with present invention.

FIG. 16 is an exploded end view of a upper-blade 70, (or 70-A) with convex/concave lenses 80-B detached and exposing LED 88 and PC-board 90, line 98 shows path of assembly for lenses to chassis wherein all blades are similarly constructed in accordance with this invention.

FIG. 17 is a vertical fragmentary view of a upper-blade 70-A without lens, showing a chassis 92-B, a PC-board 90 with LEDs 88 affixed thereto, (whereas both upper-blades 70, 70-A are identically constructed with a PC-board 90 and an array of LED 88 mounted to PC-board), showing is a gudgeon 66 through which rivet/pin are placed to form hinge joint with a base-blade 56, (as in FIGS. 1-A and 9) showing is a retainer-clip 74-B that mates with a retainer-clip 74-A on base-blade 56 whenever said device is in storage, (as with retainer-clip 74 and 74-C in FIG. 14), also showing a upper-blade 70-A having a rib 86 (to reinforce the part of upper-blades that is not overlapping). The base-blade 56 as in FIG. 7, and 8 is similarly constructed as both upper-blades 70, 70-A with multiple LEDs 88, affixed to a PC-board 90, duly mounted to the chassis 92 using PC-retainer-clips 84, insulated wires passed through orifice 26 located in flange 52 (as in FIG. 8) connecting to a PC-board 90 in base-blade 56 using fastening means; using fastening means to connect insulated wires at both ends of PC-board 90 located in base-blade 56, place wiring through orifices 26-A and 26-B, coil insulated wire around in wiring-groove 94, and 94-A to allow flexibility of the wiring within the hinge-joint of upper-blade 70, 70-A, and base-blade 56, put wire through orifices 26-A, 26-B of upper-blades 70 and 70-A, and connect the wire to PC-boards in both upper-blade 70 and 70-A using fastening means, after connecting insulated wiring to PC-board, orifice 26, 26-A, and 26-B are then sealed with sealant means to ensure watertight integrity within said invention, affix all concave/convex translucent reflective lenses to chassis using a proper sealant to further ensure a totally moisture free environment within said device. Subsequent to construction of upper-blade 70, 70-A and base-blade 56, added sealant is applied within crevice of all protective-edges 82, 82-A, and concave/convex-translucent-reflective-lenses 80-80-B of all blades, as in FIG. 16.

### ALTERNATIVE EMBODIMENTS

With regards to flat-lenses 81, 81A, and 81B as in FIG. 14 wherein the lenses has a flat outer surface unlike the illustrations in FIG. 16, wherein the lenses of FIG. 16 having a concave/convex shape.

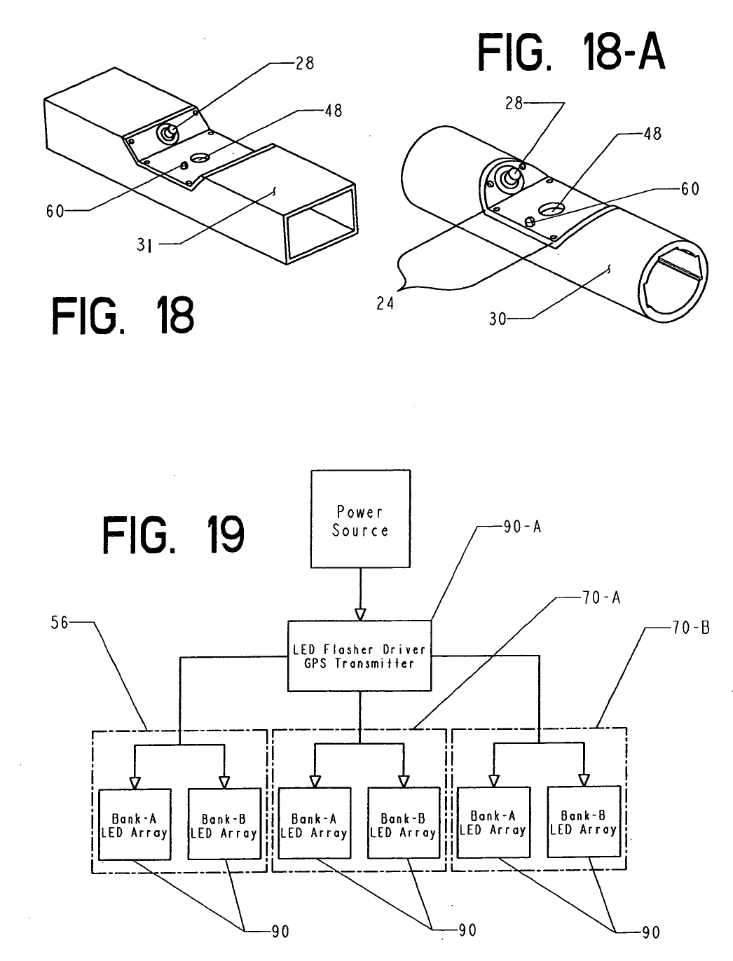

FIG. 18 is a rectangular base 31 that could otherwise be used with this invention.

Operation:

In the operation of this invention one would use the Improved Light Emitting Reflective Hazard Alert Unit in the purpose intended, such as: a proper beacon for potential hazard; likewise an alternative use on winding dark one lane country roads as a reference for hidden driveways. Or in the event of poor driving conditions the GPS transmitter aid in early warning providing that approaching vehicles are equipped with GPS.

Four simple steps to complete in achieving a hazard alert unit in accordance with this invention:

Step 1; remove invention from storage box

Step 2, to achieve intended triangular configuration of this invention t for deployment (after removing from box) raise both upper-blades 70 and 70-A as in FIG. 9, following lines 100-100 simultaneously creating a scissors like motion from collapsed to erect position, at end of upward travel both upper-blades 70 and 70-A must be shifted to opposite sides of each other where studs 76, 76-A (76-A not visible) and snap-lock 78, 78-A as in FIGS. 10, 13. bringing upper-blades together overlapping and interlocking as in FIG. 11 using snap-lock 78, 78-A and studs 76, 76-A (76-A not visible) as in FIGS. 9,10,11, and 13.

Step 3, after configuration of the triangular portion of said invention then rotate triangle clockwise, until stopped by the rotation-stop 58, and 60 while base 56 remain stationary.

Step 4, the final step in the procedure is to deploy said invention at prescribed distance away from potential hazard, setting down unit on roadway/ground with stabilizers 54, 54-A and adhesive-friction-pad 32, 32-A thus keeping said invention from sliding around in high wind, by pressing on/off switch 28 located in the on flange-mount 24 deployment is complete. This device will operate for over 30 hours continuously. the use of LEDs which produce almost no heat, the chances of hot/cold condensation is to a minimal therefore the invention can be operated in cold temperatures as a beacon.

To disassemble and store said invention:

Step 1, turn device off.

Step 2, squeeze firmly on release-boss 72, and 72-A unlocking both upper-blade 70, and 70-A.

Step 3, fold upper-blades 70, and 70-A downwards following line 100 (as in FIG. 9) to base-blade 56 where all retainer-clips 74, 74-A, 74-B, and 74-C are interlocked (as in FIG. 14)

Step 4, rotate triangular portion of device anticlockwise, locking the stabilizers 54, 54-A in stabilizer-recesses 22, 22-A as in FIGS. 1, 2, and 3.

Step 5, return said invention to storage

Conclusion, Ramifications, and Scope

Respectively, the reader will see that the GPS, light emitting, and reflective ability of this invention is readily practical for use on today's highways, furthermore the device will be constructed from some recycled material and is affordable, said invention has additional advantages in that:

(a) It permit use in vehicles where weight and space is a factor, by not being overtly bulky or heavier than those of it's same class and are in use today.

(b) It permits total mobility with no strings attached due to having integral circuitry, and power source.

(c) It reflect light continuously while illuminating on interval using a specified amount of light emitting diodes that project a clearly visible triangular image across great distance with the oscillation illumination of bank-A, and bank-B.

(d) It allows wind to flow through and around it due to a unique shape and design whereby using concave/convex lenses, and a cylindrical base the wind passes easily around said invention wherein the use of wind-slots in the flat inner portions of frame allowing wind to pass through thus reducing wind pressure against said invention keeping it from being blown about in high wind.

(e) It is totally moisture proof/resistant as a result of proper means for sealing and fastening, fusing the concave/convex lenses to chassis then adding sealant to crevice between concave/convex lenses and outer protective-edge of frame along with O-rings around the openings of base and moisture proof on/off switch.

(f) It use a GPS transmitter that is activated when device is turned on, to alert vehicles equipped with onboard navigation systems (via satellite) of a stalled motor vehicle up ahead during poor driving conditions, such as dense fog or near blinding cloud burst.

The above description has lots of specificity; they should not be construed as a limit for the scope of the present invention but rather providing illustrations of the presently preferred embodiments of this invention. For example, the device can have other shapes such as a recangulr-elongated base. A base made partly from rubber, or other non-slip materials, and lenses that are flat on the broader surface area.

We claim:

1. An improved light emitting reflective hazard alert unit, comprising:
(a) means for illumination, reflecting light and
(b) means for global positioning system transmitting and
(b) means for wind deflection, with
(c) ability to configure a triangular structure when needed and ability to fold when not in use.

2. An improved light emitting reflective hazard alert unit as in claim 1
(a) wherein the improvement comprises a plurality of light emitting diodes affixed to a printed-circuit sandwiching between a plurality of concave/convex-translucent-reflective-lenses of two identical upper-blades and a base-blade, said printed-circuits is constructed to oscillate light between at least two circuit banks in communication to a light emitting-diode-driver so that oscillating illumination is constantly visible providing hazard alert
(b) wherein the improvement comprises a global positioning system transmitter which is activated simultaneously when said device is turned on so that the device communicate via satellite with vehicles equip with navigational system thereby providing hazard alert
(c) wherein the improvement comprises said base-blade and said two identical upper-blades are of curvature construction thereby deflecting high winds, further including a plurality of wind-slots thereby allowing passage of air through said wind-slots, thereby reducing wind pressure against present invention when members respectively configure a device traditionally symbolizing caution.

3. An improved light emitting reflective hazard alert unit, comprising:
(a) at least four batteries light control means and global positioning system means are disposed within a cylindrical base or otherwise elongated rectangular base providing a proper base-weight in accordance with this present invention
(b) members that are substantially constructed using a proper means for sealant thereby maintaining watertight integrity throughout said device in accordance with this present invention.
